(19) United States
(12) Patent Application Publication
(10) Pub. No.: US 2022/0157066 A1
(43) Pub. Date: May 19, 2022

(54) MULTIPLEX PROCESSING OF IMAGE SENSOR DATA FOR SENSING AND AVOIDING EXTERNAL OBJECTS

(71) Applicant: A^3 by Airbus, LLC, Sunnyvale, CA (US)

(72) Inventors: Nima Rahnemoon, Sunnyvale, CA (US); Alexander Dean Naiman, Santa Clara, CA (US); Arne Stoschek, Palo Alto, CA (US)

(73) Assignee: A^3 by Airbus, LLC, Sunnyvale, CA (US)

(21) Appl. No.: 17/599,955

(22) PCT Filed: Mar. 29, 2019
(86) PCT No.: PCT/US2019/024991

§ 371 Date: Sep. 29, 2021

(51) Int. Cl. G06V 20/58; G06V 20/17; G06V 10/34; H04N 7/18; G06V 10/25; G05D 1/10

(52) U.S. Cl. CPC G06V 20/58; G06V 20/17; G05D 1/106; H04N 7/18; G06V 10/25; G06V 10/34

(57) ABSTRACT

A monitoring system for an aircraft has sensors configured to sense objects around the aircraft and provide data indicative of the sensed objects. The system contains a first type of computing module that processes data obtained from all the sensors and a second type of computing module dedicated to processing data from a particular sensor. The second module may characterize and locate a detected object within the processed image data. Both the first and second modules generate a likelihood of detection of an object within their processed image data. A scheduler module calculates a percentage of computing resources that should be assigned to processing data from a respective image sensor in view of this likelihood and assigns a dedicated compute module to an image sensor requiring a higher percentage of attention. Processing resources may therefore be focused on geospatial areas with a high likelihood of object detection.

### BACKGROUND

Aircraft may encounter a wide variety of collision risks during flight, such as debris, other aircraft, equipment, buildings, birds, terrain, and other objects, any of which may cause significant damage to an aircraft and/or injury to its occupants. Because objects may approach and impact an aircraft from any direction, it may be difficult to visibly see and avoid all potential obstacles. Sensors may therefore be used to detect objects that pose a collision risk and warn a pilot of detected collision risks. In a self-piloted aircraft, sensor data indicative of objects around the aircraft may be used to avoid collision with detected objects.

To ensure safe and efficient operation of an aircraft, it is desirable for an aircraft to detect objects in all of the space around the aircraft. However, detecting objects around an aircraft and determining a suitable path for the aircraft to follow in order to avoid colliding with the objects can be challenging. Systems capable of performing the assessments needed to reliably detect and avoid objects external to the aircraft may be burdensome to implement. For example, the hardware and software necessary to handle large amounts of data from external sensors, as well as the sensors themselves, may add additional constraints on the aircraft, as such components have their own resource needs.

To illustrate, a self-piloted aircraft may have, on its exterior, a large number of image sensors, such as cameras, that provide sensor readings for a full, 3-dimensional coverage of the spherical area surrounding the aircraft. The data collected from these image sensors may be processed by one or more processing units (e.g., CPUs) implementing various algorithms to identify whether an image captured by a camera depicts an object of interest. If an object of interest is detected, information about the object may be sent to avoidance logic within the aircraft, to plan a path for escape. However, the number of cameras required to fully image the area around the aircraft may create problems during operation. In one instance, an excessive number of cameras may be impracticably heavy for smaller aircrafts. Additionally, a large number of cameras, working simultaneously, may have high power needs, high bandwidth needs, high computational needs, or other requirements which may be prohibitive to the effective function of the aircraft.

As one example, an aircraft may be built with a number of cameras, each having a 30-degree field of view. To capture images from the entirety of the spherical area surrounding the aircraft, 100 cameras may need to be installed. With regard to power, if each camera uses about 10 W, then the totality of cameras, along with any other computational devices required to support them may need, e.g., several hundred, or possibly 1000 W of power. With regard to bandwidth, transport of camera data to different computing elements may be stymied or bottlenecked by bandwidth limitations. Known reliable transport protocols allow transport of 40 Gb/sec, however, these protocols may be limited to the transport of data within a computer bus, and may not allow for reliable transport across longer distances, such as between different parts of a midsize or large aircraft. Even protocols that might allow for such transport may be limited to, e.g., transport of 2 Gb/sec. Therefore, architectures capable of transporting the high amounts of data generated by the image sensors may require a large number of wires. Still further, with regard to computational constraints, even state of the art algorithms for object detection may not be able to process data quickly enough to meet the needs of the aircraft. One exemplary well-known algorithm for object detection is YOLO (“you only look once”), which is based on predicting a classification of object and a boundary box specifying the object's location. The YOLO algorithm is relatively fast because it processes an entire image in one run of the algorithm. However, even at YOLO's processing speed of about 30 frames/sec, the image data from one of the above-discussed example cameras would only be processed over the course of 100 seconds. Accordingly, a large number of computing elements may be needed to correspond to a large amount of image data.

Therefore, solutions allowing for robust, highly-reliable processing of data from a large number of image sensors, while reducing the bandwidth, computing, and/or architectural constraints in transporting and processing such data, are generally desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 is a diagram illustrating a perspective view of an aircraft having an aircraft monitoring system in accordance with some embodiments of the present disclosure.

FIG. 2 is a diagram illustrating a field of view of one or more sensors surrounding around an aircraft having an aircraft monitoring system in accordance with some embodiments of the present disclosure.

FIG. 3 is a diagram illustrating an architecture of a sensing system in accordance with some embodiments of the present disclosure.

FIG. 4 is a block diagram illustrating a sensing system in accordance with some embodiments of the present disclosure.

FIG. 5 is a flow chart illustrating a method for processing sensor data in accordance with some embodiments of the present disclosure.

FIG. 6 is a block diagram illustrating a sensing system in accordance with some embodiments of the present disclosure.

FIG. 7 is a block diagram illustrating a sensing system in accordance with some embodiments of the present disclosure.

FIG. 8 is a diagram illustrating a heat map in accordance with some embodiments of the present disclosure.

FIG. 9 is a flow chart illustrating a method for processing sensor data in accordance with some embodiments of the present disclosure.

FIG. 10 is a block diagram illustrating a sensing system in accordance with some embodiments of the present disclosure.

### DETAILED DESCRIPTION

The present disclosure generally pertains to a system for sensing and avoiding external objects in autonomous aircrafts, in which incoming image data can be managed and processed in a compute-constrained environment. In particular, the present disclosure pertains to a detection system that directs constrained computing resources to the processing of the most valuable, or potentially valuable, portions of sensor data. In a preferred embodiment, an aircraft may include a “sense and avoid” system which is generally directed to the collection and interpretation of sensor data to determine whether a detected object is a collision threat, and, if so, to provide a recommendation of an action to be taken by the aircraft to avoid collision with the sensed object. In some embodiments, an aircraft includes a number of image sensors, such as cameras, capable of generating 2-dimensional image data. Each of the sensors is capable of sensing objects within the sensor's field of view and generating sensor data from which information about the sensed objects can be determined. The aircraft may then be controlled based on an interpretation of the sensor data.

In one embodiment, each of a plurality of image sensors (e.g., one or more optical cameras, thermal cameras, RADAR, and the like) feeds image data into a multiplexer module. A “detection compute” module serially processes data from each of the feeds from all of the image sensors (also referred to herein as a “streams”). One or more “dedicated compute” modules processes data from the feeds of one or a subset of the image sensors with images that potentially contain a detected object. The dedicated compute modules contain logic capable of classifying the detected object and/or of determining various attributes of the object, and output this information to a path planning module that determines a path to avoid the object, if necessary. Additionally, a “scheduler” module schedules which information, of the totality of information collected from the image sensors, should be respectively processed by the detection compute and/or the dedicated computes.

As explained above, the detection compute module serially analyzes image data, obtained from the multiplexer module, from all of the image sensors in a round-robin manner. This is done, for example, by first processing an image collected from a first image sensor, then processing an image collected from a second image sensor, and so on. The detection compute outputs to the scheduler module, for each image sensor, a likelihood of detection; that is, a value indicating the likelihood that an object of interest appears in the image corresponding to the image sensor. In a case where the detection compute module does not detect any objects in the image, the likelihood of detection may be low. In a case where it is possible or likely an object appears, the likelihood of detection is higher. The likelihood of detection values are sent to the scheduler module, which stores this information in a table (or similar data structure). The scheduler then, based on a normalization of the stored likelihood of detection values, calculates, for each image sensor, an attention percentage corresponding to a percentage of computing resources that should be assigned to processing data from a respective image sensor. Based on the calculated attention percentages, the scheduler module may assign (or may instruct the multiplexer module to assign) one of the dedicated compute modules to an image stream corresponding to a designated image sensor. By these means, intelligent computation is done by the scheduler and the dedicated computes with focus on image streams potentially showing an object or area of interest.

In an alternate embodiment, rather than one detection compute module, a detection compute module (in the form of, e.g., an FPGA or ASIC) could be attached to each image sensor, and the actions of the detection compute module may be performed entirely through circuitry.

In another alternate embodiment, where an image sensor is a CMOS camera (complementary metal oxide semiconductor) that permits dynamic zoom, the scheduler module may, in addition to assigning a dedicated compute module to an image sensor stream, also specify a level of zoom at which the dedicated compute should analyze the stream. The CMOS camera may be, for example, a camera capable of being panned or tilted. In an alternate embodiment, rather than assign a level of zoom, multiple cameras with different fixed zoom levels may be provided and the scheduler module may choose between cameras to obtain an image with an appropriate zoom level. The fixed-zoom cameras may be panned and/or tilted to image different areas of space. Such an implementation allows for a rapid response that mitigates or avoids latency due to limitations of the speed of the zoom motor when altering the level of zoom.

In yet another embodiment, rather than a multiplexer module into which all of the image streams flow, a number of mixers are used, each mixer having access to all of the image streams. In this embodiment, the scheduler module receives a set of “heat maps” from the detection compute module and the dedicated compute modules, the heat maps laying out the particular portions of the field of view of the image sensors that are most and least likely to contain an object of interest. Based on these heat maps, the scheduler module calculates a global heat map corresponding to an entire spherical field of view (FOV) around the aircraft. The scheduler, using the global heat map, instructs a mixer to focus on one or more particular portions (or areas) of the field of view of the aircraft, by sending the mixer a center point of observation, one or more values indicating a size of the area to be observed (e.g., pitch/yaw), and a resolution at which to capture images. Each mixer generates a customized image corresponding to their assigned area of observation through image cropping/stitching of data from the image sensors. This customized image is provided to a dedicated compute module for analysis. By these means, the dedicated compute modules are provided with intelligently selected areas of interest, which areas are not limited to the field of view of any single image sensor.

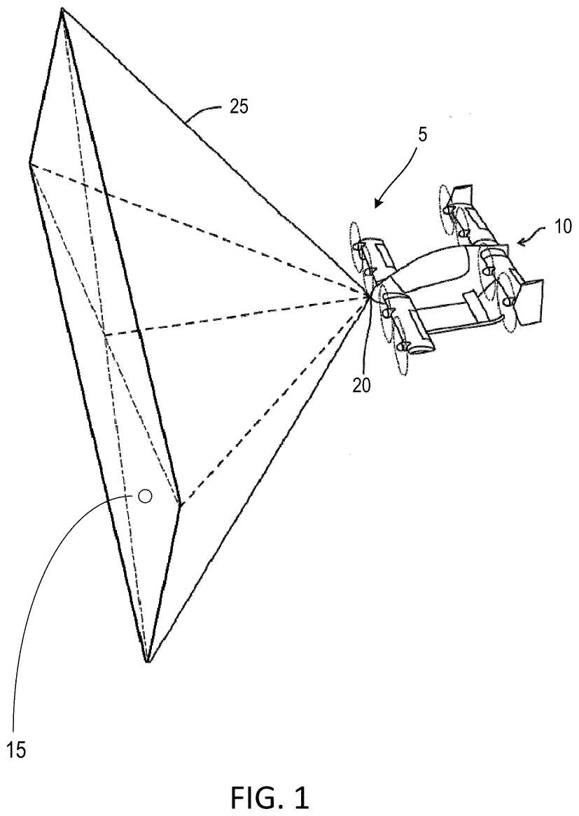

FIG. 1 depicts a perspective view of an aircraft 10 having an aircraft monitoring system 5 in accordance with some embodiments of the present disclosure. FIG. 1 depicts the aircraft 10 as an autonomous vertical takeoff and landing (VTOL) aircraft 10, however, the aircraft 10 may be of various types. The aircraft 10 may be configured for carrying various types of payloads (e.g., passengers, cargo, etc.). In other embodiments, systems having similar functionality may be used with other types of vehicles 10, such as automobiles or watercraft. In the embodiment illustrated in FIG. 1, the aircraft 10 is configured for self-piloted (e.g., autonomous) flight. As an example, aircraft 10 may be configured to perform autonomous flight by following a predetermined route to its destination, under the control of a flight controller (not shown in FIG. 1) on the aircraft 10. In other embodiments, the aircraft 10 may be configured to operate under remote control, such as by wireless (e.g., radio) communication with a remote pilot. Alternatively or additionally, the aircraft 10 may be a manned or partially-autonomous vehicle.

In the embodiment of FIG. 1, the aircraft 10 has one or more sensors 20 for monitoring space around aircraft 10. Sensors 20 have a field of view (FOV) 25 in which the sensors 20 may detect the presence of objects 15. Note that field of view need not necessarily imply that a sensor is optical (though, in some embodiments, it may be), but rather generally refers to the region over which a sensor is capable of sensing objects, regardless of the type of sensor that is employed. Further, although the FOV 25 is depicted in FIG. 1 as being relatively rectangular or polygonal, the shape and/or range of the FOV of a sensor may vary in different embodiments. Although only one sensor 20 is shown in FIG. 1 for ease of illustration, any number of sensors, and any number of types of sensors, may comprise the illustrated sensors 20. The use of additional sensors may expand the area in which the aircraft monitoring system 5 can detect objects. In general it will be understood that the sensors are arranged to provide full coverage of the (roughly-spherical) space around the aircraft. To that end, sensors 20 may be placed at different parts of the aircraft 10, e.g., top and bottom, front and back, etc., in order for each respective sensor to obtain a different image feed. In a preferred embodiment, little or no overlap is present in the areas monitored by respective sensors, nor is any area left unmonitored (that is, no blind spots exist); however, other arrangements may be possible in other embodiments.

In some embodiments, sensor 20 may include at least one camera for capturing images of a scene and providing data defining the captured scene. While an aircraft may use a variety of sensors for different purposes, such as optical cameras, thermal cameras, electro-optical or infrared (EO/IR) sensors, radio detection and ranging (radar) sensors, light detection and ranging (LIDAR) sensors, transponders, inertial navigation systems, or global navigation satellite system (INS/GNSS), among others, it may be generally understood that the sensors 20 discussed herein may be any appropriate optical or non-optical sensor(s) capable of obtaining a 2-dimensional image of an area external to the aircraft. For purposes of explanation, sensors 20 are described herein as having similar or identical fields of view (FOV), however, in alternate embodiments, it is possible for the capabilities (e.g., field of view, resolution, zoom, etc.) of different sensors installed on a single aircraft to vary. For example, where sensor 20 comprises one or more optical cameras, the field of view 25 may differ based on properties of the camera (e.g., lens focal length, etc.). In some embodiments, the sensors 20 are in a fixed position so as to have a fixed field of view, however, in other embodiments, sensors may be controllably movable so as to monitor different fields of view at different times.

The aircraft monitoring system 5 of FIG. 1 is configured to use the sensors 20 to detect an object 15 that is within a certain vicinity of the aircraft 10, such as near a flight path of the aircraft 10. Such sensor data may then be processed to determine whether the object 15 presents a collision threat to the vehicle 10. The object 15 may be of various types that aircraft 10 may encounter during flight, for example, another aircraft (e.g., a drone, airplane, or helicopter), a bird, debris, or terrain, or any other of various types of objects that may damage the aircraft 10, or impact its flight, if the aircraft 10 and the object 15 were to collide. The object 15 is depicted in FIG. 1 as a single object that has a specific size and shape, but it will be understood that object 15 may represent one or several objects at any location within the field of view, and object(s) 15 may take any of a variety of shapes or sizes and may have various characteristics (e.g., stationary or mobile, cooperative or uncooperative). In some instances, the object 15 may be intelligent, reactive, and/or highly maneuverable, such as another manned or unmanned aircraft in motion.

The aircraft monitoring system 5 may use information from the sensors 20 about the sensed object 15, such as its location, velocity, and/or probable classification (e.g., that the object is a bird, aircraft, debris, building, etc.), along with information about the aircraft 10, such as the current operating conditions of the aircraft (e.g., airspeed, altitude, orientation (such as pitch, roll, or yaw), throttle settings, available battery power, known system failures, etc.), capabilities (e.g., maneuverability) of the aircraft under the current operating conditions, weather, restrictions on airspace, etc., to generate one or more paths that the aircraft is capable of flying under its current operating conditions. This may, in some embodiments, take the form of a possible path (or range of paths) that aircraft 10 may safely follow in order to avoid the detected object 15.

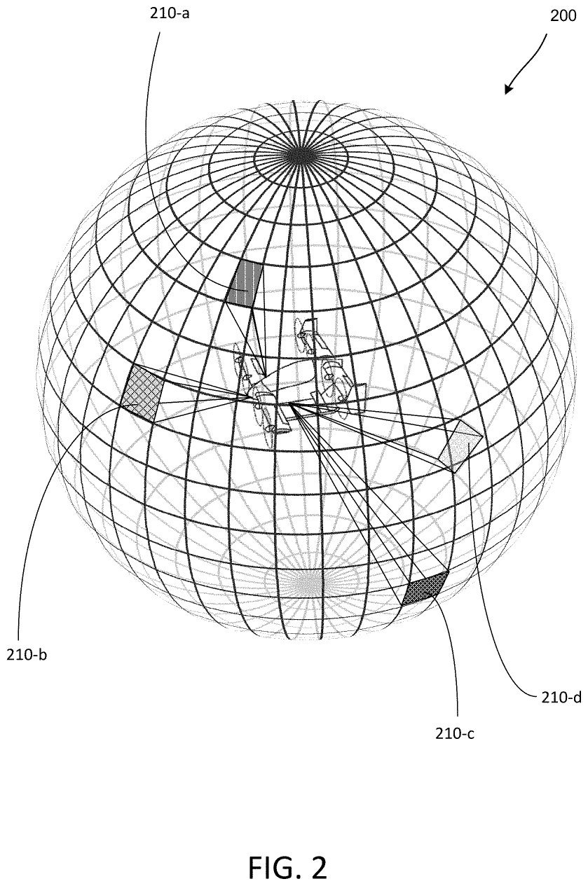

FIG. 2 depicts a spherical area 200 that can be collectively observed and imaged by a plurality of sensors 20. In the embodiment illustrated in FIG. 2, sensors 20 are attached to an exterior of the aircraft 10 such that each sensor has a field of view corresponding to a different respective area of space around the aircraft, however, in other embodiments, the field of views of different sensors may overlap at parts or otherwise have redundancy. FIG. 2 illustrates these respective areas as curved planes 210 (also referred to herein as “rectangles” in correspondence to a 2-D image), the entirety of which can be captured in a single image from a sensor 20. FIG. 2 indicates a plurality of areas (four such areas being numbered as 210-a, 210-b, 210-c, and 210-d), each corresponding to a separate image sensor 20, however any number of areas may exist in different embodiments. In general it will be understood that the number of areas corresponds to a number of image sensors, that is, if an aircraft 10 is outfitted with n image sensors 20, then n such areas in the space around the aircraft are imaged by the sensors. However, in an alternative embodiment, two or more of areas 210 may be variously monitored by a single camera when the camera is moved or focused to different positions, such that the areas are imaged by the same camera at different times. Additionally, it will be noted that while the term “spherical” or “sphere” is used herein, the comprehensive monitored space around the aircraft 10 is not limited to any particular shape, and various embodiments may monitor variously-shaped portions of real space. Further, in some embodiments, based on the needs of an aircraft and its operator(s), images of the full 360° space around the aircraft may not be necessary, and embodiments may exist where only a portion of such space is monitored (or is monitored at one time).

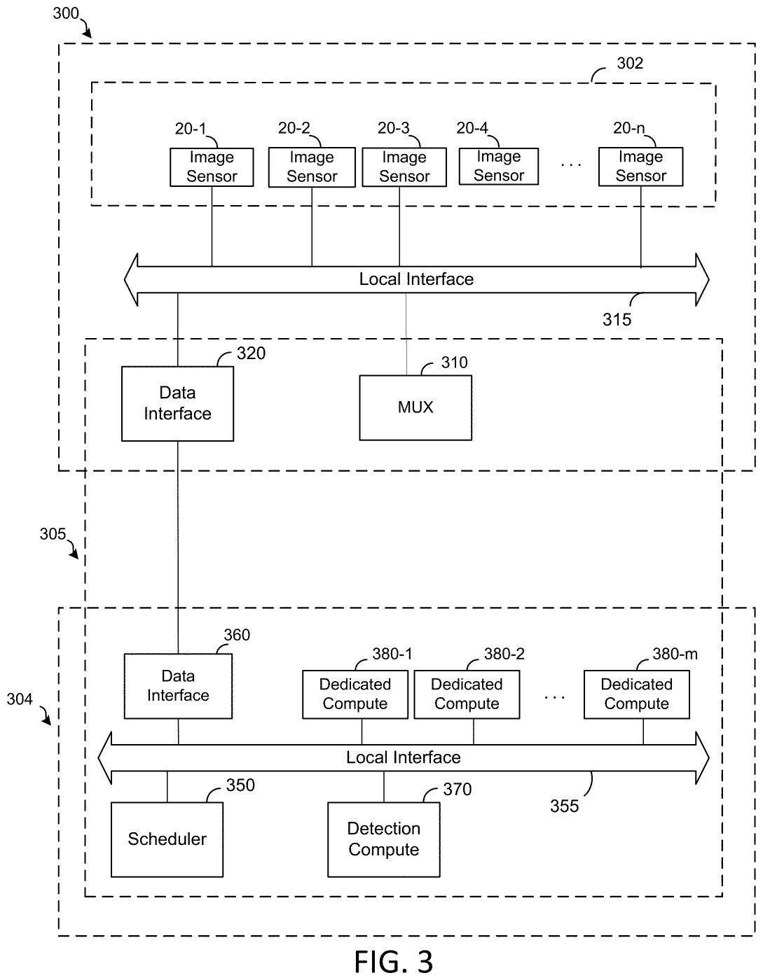

With reference to FIG. 3, aircraft monitoring system 5 may include, in addition to the one or more sensors 20 (collectively, element 302), a sensing system 305 made up of one or more computational modules, which are described further herein. In some embodiments, elements of sensing system 305 may be coupled to one or more of sensors 20. The sensing system 305 provides information about a detected object (such as its classification, attributes, location information, and the like) to a path planning system (not specifically shown) that may perform processing of such data (as well as other data, e.g., flight planning data (terrain and weather information, among other things) and/or data received from an aircraft control system) to generate a recommendation for an action to be taken by an aircraft controller. A combination of some components from the sensors 20, the sensing system 305, and the path planning system may function together as the “sense and avoid” system.

Components of the aircraft monitoring system 5 may reside on the aircraft 10 and may communicate with other components of the aircraft monitoring system 5 through wired (e.g., conductive) and/or wireless (e.g., wireless network or short-range wireless protocol, such as Bluetooth) communication, however alternate communication protocols may be used in different embodiments. Similarly, subcomponents of the above-described parts, such as individual elements of the sensing system 305, may be housed at different parts of the aircraft 10. As one example, sensors 20 may be housed on, e.g., the wings of the aircraft 10, while one or more of a multiplexer 310, scheduler 350, detection compute 370, or dedicated computes 380-1 to 380-m (collectively 380), which are described in greater detail below, may be housed in a central portion of the aircraft. Of course, it will be understood that the components or subcomponents may be alternately arranged, for example, in one embodiment where the multiplexer, scheduler, and detection compute are on the same physical machine while running as different software modules. For example, sensors 20 are not limited to placement on a wing of the aircraft and may be located at any location on the aircraft that will allow for sensing of the space outside the aircraft. Other components may be located near the sensors 20 or otherwise arranged to optimize transport and processing of data as appropriate.

It will be understood that the components of aircraft monitoring system 5 described above are merely illustrative, and the aircraft monitoring system 5 may comprise various components not depicted for achieving the functionality described herein and generally performing collision threat-sensing operations and vehicle control. Similarly, although particular functionality may be ascribed to various components of the aircraft monitoring system 5 as discussed herein, it will be understood that a 1:1 correspondence need not exist, and in other alternate embodiments, such functionalities may be performed by different components, or by one or more components, and/or multiple such functions may be performed by a single component.

The sensors 302 and the sending system 305 may be variously implemented in hardware or a combination of hardware and software/firmware, and are not limited to any particular implementation. Exemplary configurations of components of the sensing system 305 will be described in more detail below with reference to FIGS. 3-10.

Multiplexed Architecture

As described above, FIG. 3 illustrates a block view of the sensing system 305 along with a plurality of image sensors, labeled collectively as block 302. FIG. 3 illustrates that the block of image sensors 302 is made up of n image sensors 20 (labeled individually as 20-1, 20-2, 20-3, 20-4, . . . 20-n). An image sensor may be, e.g., an optical camera, thermal camera, RADAR sensor, CMOS, or any other appropriate sensor capable of collecting 2-D sensor data, though for purposes of explanation in the present disclosure, the terms “image sensor” and “camera” may be alternatively used. It will be understood that n may be any non-zero number, in different embodiments, provided that the aircraft 10 is able to support a quantity of n sensors. For example, an aircraft large enough to carry passenger traffic may be able to carry the weight of a greater number of cameras than, e.g., a drone. In one example embodiment, each of the cameras (image sensors) installed on an aircraft may have a 30-degree field of view, thereby necessitating 100 cameras to fully monitor the spherical area surrounding the aircraft 10, though it will be understood that image sensors are not limited to any particular field of view, and need not have identical capabilities.

Sensing system 305 is illustrated in FIG. 3 as comprising a number of modules including a multiplexer (MUX) 310, a scheduler 350, a detection compute 370, and a plurality of dedicated computes 380 (individually labeled as 380-1, 380-2, . . . 380-m). Each module may be implemented through hardware or software or any combination thereof. For example, the respective modules may, in some embodiments, include one or more processors configured to execute instructions to perform various functions, such as the processing of sensor data from the sensors 302, and may include, for example, one or more of central processing units (CPU), digital signal processors (DSP), graphics processing units (GPU), application-specific integrated circuits (ASICs), field-programmable gate arrays (FPGAs), and/or microprocessors programmed with software or firmware, or other types of circuits for performing the described functionalities, or any combination thereof. In one embodiment, the detection compute 370 may include, e.g., an FPGA, while the scheduler 350 and dedicated computes 380 (which perform computation-intensive functions, as described in greater detail below) may be implemented, e.g., by a CPU. The respective modules may, in some embodiments, include a dedicated memory, and may alternately, in other embodiments, reference a shared memory (not shown).

The modules of sensing system 305 may communicate to and/or drive other modules via the local interfaces 315, 355, which may include at least one bus. Further, the data interfaces 320, 360 (e.g., ports or pins) may interface components of the sensor system 305 with each other or with other components of the aircraft controller system 5. In the embodiment illustrated in FIG. 3, the sensors 302 and multiplexer 310 (together, element 300) may communicate with each other via local interface 315, and the scheduler 350, detection compute 370, and dedicated computes 380 (together, element 304) may communicate with each other via local interface 355. Components of element 300 may communicate with components of element 304 via data interfaces 320 and 360. In this example configuration, the number of necessary wires is reduced; that is, while a large number of wires is needed to send information from the n image sensors to the multiplexer 310, the distance over which those wires must span may be shortened (e.g., where the components of element 300 are contained within one wing or area of an aircraft 10). Similarly, while the distance over which data must travel between the multiplexer and the components of element 304 may be relatively long (e.g., where the components of element 304 are contained within a central part of the aircraft), the number of wires that must run that distance is small (e.g., significantly smaller than n). It will be understood, however, that other configurations are possible in other embodiments.

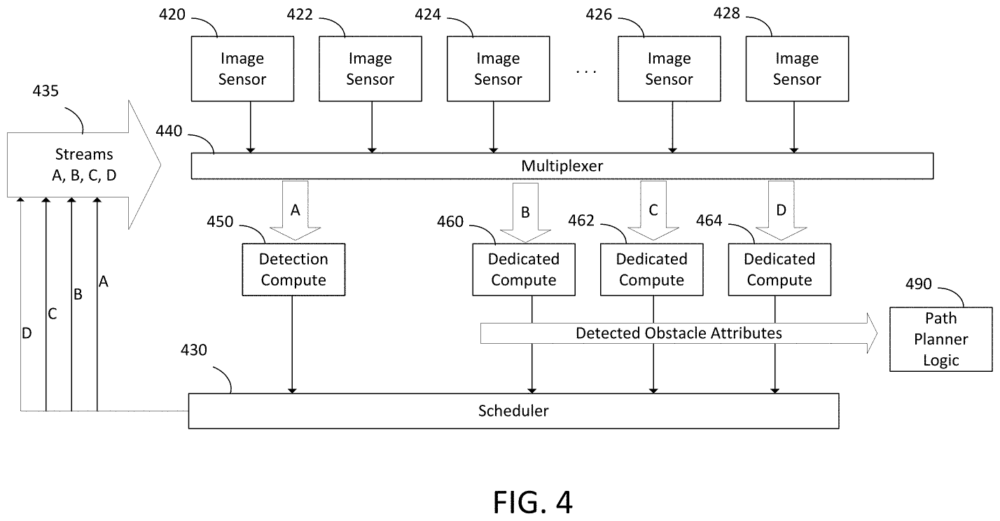

FIG. 4 diagrams a logical flow between the image sensors and the components of the sensing system. Each of a plurality of image sensors (labeled as 420, 422, 424, 426, and 428, though any practical number of image sensors may be used in different embodiments) feeds image data into the multiplexer 440. Multiplexer 440 may direct image streams with data from those image sensors into one or more “compute” modules. The image streams need not necessarily correspond to the image sensors in a 1:1 correspondence, and instead, an image stream may in some instances (or at some times) contain data from more than one image sensor and/or the information contained in the various image streams may be wholly or partially duplicative of information in another stream. In the embodiment of FIG. 4, for instance, multiplexer 440 may output four image streams A-D, while taking in data from five or more image sensors. The selection of data to include in an image stream and the direction of the particular image streams to particular compute modules is done by the multiplexer 400 based on instructions from the scheduler 430, in a manner described in greater detail below.

In an initial instance, where multiplexer 440 has not yet received instruction from the scheduler 430, the multiplexer only directs data through image stream A to “detection compute” 450. Detection compute 450 processes all of the feeds from the image sensors in a round-robin manner, cycling serially through the images collected from the image sensors. In one embodiment, detection compute 450 processes images through any known object detection algorithm, along with additional processing as described herein. In the embodiment of FIG. 4, the detection compute may continuously cycle through each of the image sensors 420-428 (or through any number of active image sensors, in other embodiments) so as to receive image data corresponding to the full range of view of the spherical area external to the aircraft. In some embodiments, the image sensors may be configured to capture less than the entirety of the full spherical area, in which case the detection compute receives image data corresponding to the full range of view captured by the image sensors The image stream reviewed by the detection compute 450 (stream “A” in FIG. 4) therefore contains data from all the image sensors 420-428.

In addition to the image stream A sent to the detection compute, the multiplexer may also direct image data to one or more “dedicated computes” 460, 462, 464. These dedicated computes contain advanced algorithms capable of monitoring a detected object as it appears in an image stream specified by the multiplexer 440, and analyzing, classifying, and/or localizing that object. In contrast to the detection compute, which processes (to some degree) data from all of the image sensors, any respective one of the dedicated computes looks only to data from one or a subset of image sensors. The image streams B-D therefore respectively contain data from a subset of the image sensors 420-428. The particular image data to be included in any of image streams B-D are filtered by the multiplexer 440 based on instructions sent by the “scheduler” 430. Scheduler 430 schedules the information that should be respectively processed by the detection compute and the dedicated computes. This process of scheduling can be seen in the embodiment of FIG. 4.

To begin, detection compute 450 analyzes image data from all image sensors in stream A. The speed at which the detection compute processes the images is limited by its hardware, as images from the image sensors are processed one at a time. For example, where the detection compute runs at 30 fps (frames per second), it is limited to a processing of one image from one image sensor every 3 seconds. The detection compute may use an algorithm to determine whether an image contains (or may contain) an object of interest (that is, an object that the aircraft may collide with, or may otherwise wish to be aware of). Any known algorithm could be used to make this determination, such as background subtraction, optical flow, gradient-based edge detection, or any other known algorithm capable of recognizing an object of interest. In a preferred embodiment, detection compute 450 does not contain any logic for classification of the detected object, but rather, merely outputs to the scheduler module, for each image, a likelihood of detection within an image. A likelihood of detection may be represented in a variety of ways (e.g., percentage, heat map, flag as to whether a threshold indication of likeliness is met, category (e.g., high, medium, low), among other things) but may be generally understood as a value corresponding to the likelihood that an object of interest appears in the image of a given image sensor. In the embodiment of FIG. 4, the likelihood of detection may be a percentage value ranging from zero (in a case where no objects are found) to 100 percent (gradually increasing as a certainty of detection, or another factor implicating a likelihood of collision (e.g., a size of the object) increases). In some embodiments, the detection compute may set a percentage likelihood of detection over 100% where collision is very likely or imminent.

The likelihood of detection values are sent to the scheduler 430, which stores each value in a table in association with the image sensor from which the image was taken. It will be understood that while this disclosure refers to a “table” stored by the scheduler in a memory, any appropriate data structure may be used in different embodiments. The table is, in one embodiment, stored in a memory dedicated to the scheduler (for example, to optimize the speed of read/write operations), however, in other embodiments, the scheduler may store this information in a shared or central memory. After the detection compute 450 processes an initial image from each image sensor, it continues to send updated likelihoods of detection to the scheduler 430 upon processing all subsequent images. The scheduler continually updates its table based thereon (and also in consideration of information sent from the dedicated computes 480, described in greater detail below), rewriting/updating a likelihood of detection value corresponding to an image sensor when it receives updated information about the image sensor. By these means, the scheduler maintains a current record of the likelihood that the most recent image from any particular image sensor contains an object posing a potential threat for collision. An example of this stored information is shown as Table 1.1 below:

TABLE 1.1

| Image | Detection |
|---|---|
| Sensor | Likelihood |
| 420 | 92% |
| 422 | 4% |
| 424 | 2% |
| 426 | 99% |
| 428 | 30% |

The scheduler 430 may then calculate, for each image sensor, an attention percentage corresponding to a percentage of computing resources that should be assigned to processing data from a respective image sensor. In a preferred embodiment, the calculation of the attention percentage may be done based on a normalization of the detection likelihood values. For example, with reference to the values set forth in Table 1.1, scheduler 430 may add the percentages in the “detection likelihood” column, and may determine a proportionate value of the percentage corresponding to each respective image sensor. Image sensor 420, for example, with a detection likelihood of 92% would therefore receive an attention percentage of 40.5%. An exemplary set of normalized values calculated from the values in Table 1.1, is shown in Table 1.2 below:

TABLE 1.2

| Image | Detection | Attention |
|---|---|---|
| Sensor | Likelihood | Percentage |
| 420 | 92% | 40.5% |
| 422 | 4% | 1.8% |
| 424 | 2% | 0.9% |
| 426 | 99% | 43.6% |
| 428 | 30% | 13.2% |

Based on the calculated attention percentages, scheduler 430 may assign one of the dedicated compute modules to an image stream corresponding to a designated image sensor. This assignment may be done in a variety of ways.

In a preferred embodiment, the processing capabilities of dedicated computes are optimized so as to assign a dedicated compute to process data from more than one image sensor where the computing resources of the dedicated compute can accommodate that assignment. For example, in the embodiment of FIG. 4, three (3) dedicated computes 460, 462, and 464 are available to be assigned. In a scenario where one dedicated compute can process 100 frames in a given amount of time, the three dedicated computes may collectively process 300 frames in that time. With reference to Table 1.2, for instance, image sensor 428 requires an attention percentage of 13.2%. Therefore, in one embodiment, scheduler 430 may distribute 13.2% of the total (300) frames, that is, 40 frames, to any one of the three dedicated computes. Similarly, according to Table 1.2, image sensor 422 requires an attention percentage of 1.8%, therefore, 1.8% of the frames (6 frames) will be assigned to any one of the three dedicated computes.

In this example embodiment, because image sensor 422 and image sensors 428 together require less than 100 frames of attention, the scheduler 430 may assign the same dedicated compute to process images from both image sensors. Of course, it will be understood that 100 frames is merely an example of the processing capability of a dedicated compute, and in other embodiments, a dedicated compute may be able to process more or less frames. In an alternate embodiment, a dedicated compute can be limited to monitoring the stream from one image sensor.

In another embodiment, an assigned attention percentage need not strictly dictate a number of frames to be processed by a dedicated compute, but rather, may dictate a monitoring priority. That is, where the attention percentage would strictly correlate to a number of frames exceeding the processing capabilities of a dedicated compute (e.g., as with image sensors 420 and 426 in Table 1.2, if each of three dedicated computes were limited to the processing of 100 frames), the scheduler 430 may, in one embodiment, assign a dedicated compute to exclusively monitor those image sensors. Such a configuration is shown, for example, in Table 1.3 below.

TABLE 1.3

| Image | Detection | Attention | Dedicated |
|---|---|---|---|
| Sensor | Likelihood | Percentage | Compute |
| 420 | 92% | 40.5% | 460 |
| 422 | 4% | 1.8% | 464 |
| 424 | 2% | 0.9% | 464 |
| 426 | 99% | 43.6% | 462 |
| 428 | 30% | 13.2% | 464 |

In yet another embodiment, shown in Table 1.4 below, if the attention percentage for an image sensor does not exceed a minimal value, even if the attention percentage is otherwise a non-zero value, no dedicated compute will be assigned to that sensor (though the image stream will still be monitored by a detection compute 450. Some such embodiments may have a predetermined minimal attention percentage, and alternate embodiments may intelligently determine what the minimum percentage may be, given operating conditions and certain external factors (e.g., weather, flight path, etc.). In the example of Table 1.4 below, the scheduler has determined that the attention percentages of image sensors 422 and 424 do not meet the minimum attention percentages required for the assignment of dedicated processing resources.

TABLE 1.4

| Image | Detection | Attention | Dedicated |
|---|---|---|---|
| Sensor | Likelihood | Percentage | Compute |
| 420 | 92% | 40.5% | 460 |
| 422 | 4% | 1.8% | |
| 424 | 2% | 0.9% | |
| 426 | 99% | 43.6% | 462 |
| 428 | 30% | 13.2% | 464 |

Scheduler 430, in preferred embodiments, executes logic to continually update the attention percentages for each image sensor, and to assign (or reassign/de-assign) dedicated computes to those sensors. Some embodiments of scheduler 430 may, in addition to the detection likelihoods provided by the detection compute 450 and the dedicated computes 460-464, consider external data such as operating conditions or a priori information, e.g., terrain information about the placement of buildings or other known static features, information about weather, airspace information, including known flight paths of other aircrafts (for example, other aircrafts in a fleet), and/or other relevant information

As described above, each of the dedicated computes 460-464 contains advanced logic capable of continually processing images from one or more image streams specified by the multiplexer 440, and analyzing and/or classifying any object or abnormality that may appear therein. Namely, the dedicated computes perform computationally-intensive functions to analyze image data to determine the location and classification of an object. The dedicated computes may then send classification and localization information, as well as any other determined attributes, to the path planner logic 490, which functions to recommend a path for the aircraft to avoid collision with the object, if necessary. The information sent by the dedicated computes 460-464 to the path planner logic 490 may include, for example, a classification of the object (e.g., that the object is a bird, aircraft, debris, building, etc.), a 3D or 2D position of the object, the velocity and vector information for the object, if in motion, or its maneuverability, among other relevant information about the detected object. In preferred embodiments, the dedicated computes 460-464 may employ a machine learning algorithm to classify and detect the location or other information about the object 15, however, any appropriate algorithm may be used in other embodiments.

In addition to sending such information to the path planner logic 490, the dedicated computes 460-464 may also use the location and classification information to develop a likelihood of detection that can be sent to the scheduler 430. In the case that a dedicated compute is able to classify a detected object as an object capable of communication (e.g., a drone), scheduler 430 may, in some embodiments, take into consideration a flight path of the object or other communication received from the object itself. For example, in embodiments in which scheduler 430 receives an indication of a high likelihood of detection of an object of interest, but is able to determine (directly or via another component of aircraft monitoring system 5) that a detected object in an image stream will not collide with the aircraft (e.g., if evasion maneuvers have already been taken) or that, even if a collision where to occur, no damage would be done to the aircraft (e.g., if the detected object is determined to be innocuous), or if the object is a stationary object that the aircraft monitoring system 5 is already aware of, the scheduler 430 may assign a lower attention percentage (or an attention percentage of zero) to the image sensor. If the attention percentage is zero (or, in some embodiments, below a minimal percentage), the scheduler 430 will not assign a dedicated compute to the data stream from that image sensor. In some embodiments, the scheduler 430 may employ a machine learning algorithm to determine the appropriate attention percentage for the image sensor, however, any appropriate algorithm may be used in other embodiments.

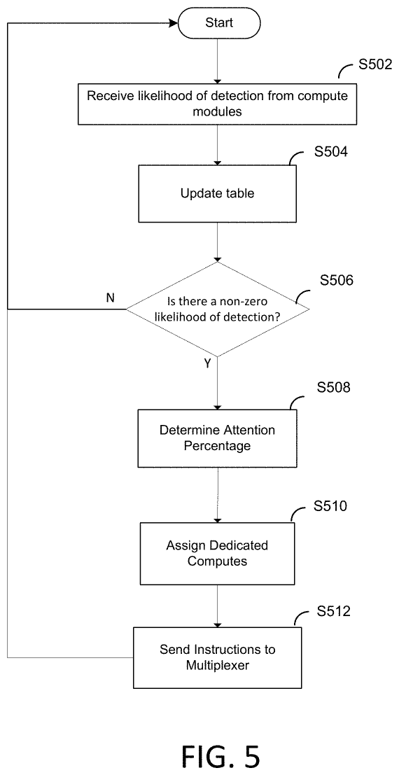

FIG. 5 illustrates a flowchart of the process followed by the scheduler in accordance with one embodiment of the disclosure. Step S502 involves the receipt, by the scheduler 430, of the likelihood of detection value from the detection compute 450 and/or the dedicated computes 380. Detection compute 450 sends the likelihood of detection values to scheduler 430 in a serial manner, viz., as detection compute 450 progresses through its review of the image streams of all of the sensors 20, it intermittently sends its detection results to the scheduler 430. Dedicated computes 460-464 send their respective likelihood of detection values for the subset of image data that they were assigned to monitor. As described earlier, the indication of the likelihood of detection may, in this embodiment, take a numeric form, e.g., a percentage value.

In the preferred embodiment, and as described above, the calculation of attention percentages is done by the scheduler 430, however, in alternate embodiments, the dedicated computes, rather than sending a likelihood of detection to the scheduler 430, may instead contain logic capable of updating/revising the attention percentage for its processed image stream, allocating the appropriate modified resources for processing, and then sending the updated attention percentage to the scheduler 430 or modifying the table in memory directly. In another embodiment, the dedicated computes may contain logic to recognize a scenario where an object has passed out of the field of view of an image sensor 420-417 to which the dedicated compute is assigned. In this scenario, the dedicated compute may obtain identifying information for the image sensor into whose field of view the object has passed (e.g., a number identifying the image sensor), and may transmit this information to scheduler 430. In yet another embodiment, the dedicated compute may obtain information identifying an image sensor into whose field of view the detected object has passed, and provides this information to the multiplexer 440 directly, so as to immediately begin processing the image sensor from that updated image sensor. In some embodiments, the dedicated computes may maintain in a memory a reference of the field of view associated with each image sensor. By implementing such logic, a dedicated compute may efficiently continue to process images related to an object that has passed between the border between two image feeds. In another embodiment, the dedicated compute may determine information regarding how its assigned image sensor(s) may be panned or tilted to capture the field of view into which the detected object has passed, and may provide this information to the scheduler 430 or the multiplexer 400, or directly to the image sensor.

By contrast, the detection compute 450, which in a preferred embodiment does not contain the robust algorithms of the dedicated computes 380, continues to process the image streams corresponding to all of the image sensors in a round robin manner and to provide the scheduler 430 with values corresponding to a likelihood of detection in those image streams.

In step S504, scheduler 430 updates a table in which it stores the information it has variously received from the detection compute 450 and the dedicated computes 460-464. While other data structures may be used in other embodiments, the embodiment of FIG. 5 uses a simple table that can be easily referenced and updated without wasted overhead or bandwidth.

Step S506 involves a determination by the scheduler 430 of whether the table contains a non-zero likelihood of detection, indicating that there is (or possibly is) at least one image stream in which an object has been detected. If any of the image sensors have, for their streams, a non-zero value of detection, the process continues to step 508, in which the scheduler 430 calculates an attention percentage based on the values for likelihood of detection. In one embodiment, the scheduler performs this calculation through a normalization of the likelihood of detection values obtained from all of the compute modules. Based on the calculated attention percentages, the scheduler 430 may then assign one or more dedicated computes 460-464 to one or more image sensors, as appropriate (Step S510). Scheduler 430 continues to assign the detection compute 450 to process data from all of the image sensors. These assignment instructions taken together (that is, to either the detection compute 450 alone or to a combination of the detection compute 450 and one or more of the dedicated computes 460-464) may be sent to the multiplexer 440 in Step S512. The multiplexer 440 in turn, implements those instructions to direct data from the image sensors to the assigned computing modules 450, 460-464.

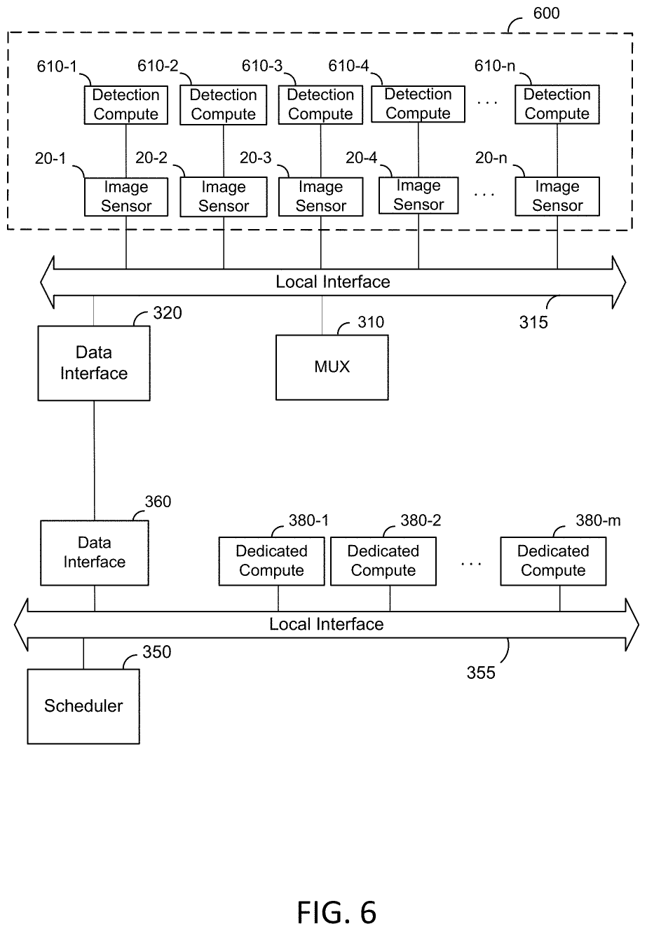

In an alternate embodiment, rather than one detection compute, an individual detection compute (e.g., an FPGA or ASIC) could be attached to each image sensor, and the actions of the detection compute module may be performed through circuitry. One such implementation is shown in FIG. 6. As can be seen, each of the image sensors 20-1 to 21-n is connected to a discrete detection compute 610-1 to 610-n, the detection computes being chips attached directly or indirectly to the image sensors. A detection compute 610 may include limited functionality circuitry that performs the same processing functionality as the earlier-described detection compute 450. In some instances, this processing may include, e.g., edge detection (or other operations) to determine a likelihood of detection of an object of interest within the image data. This information is then provided the scheduler 350 (in some embodiments, via the multiplexer 310). The scheduler, as described above, determines an attention percentage (i.e., whether any of the data is sufficiently interesting to monitor further) and may assign a dedicated computing resource 380-1 to 380-m to one or more image sensors based thereon. The dedicated computes may be, for example, a module with all or part of a CPU, and are not strictly limited to a wholly circuit-based implementation, although different implementations may be possible in different embodiments.

In another alternate embodiment, with reference once more to FIG. 4, where an image sensor is a CMOS camera (complementary metal oxide semiconductor) that permits dynamic zoom (or any other zoomable camera), scheduler 430 may, when informing the multiplexer 440 of the assignment of a dedicated compute to an image stream, also specify a level of zoom at which the dedicated compute should analyze the stream. In some embodiments, the level of zoom may be, e.g., a zoom ratio for an optical camera, and in other embodiments, the level of zoom may merely be one of high, medium, or low, or other measurements, as appropriate. The multiplexer 440 (in some embodiments, in combination with the assigned dedicated compute) may then coordinate with the appropriate image sensor(s) 20 (here, optical cameras) to capture images at the designed level of zoom. In some embodiments, the CMOS camera can be controlled so as to be panned or tilted, and such panning/tilting may be performed (in addition or alternately to a specified level of zoom) to allow the camera to focus on items viewed in a certain portion or periphery of the camera's field of view.

In another alternate embodiment, rather than assign a level of zoom, multiple cameras with different fixed zoom levels may be provided in a configuration where the same region around the aircraft may be imaged by different cameras at varying levels of zoom. In this embodiment, in response to a particular likelihood of detection, the scheduler 350 (or a dedicated compute at the instruction of the scheduler) may select a camera that is already set at an appropriate zoom level. If necessary, the fixed-zoom cameras may then be panned and/or tilted to image different areas of space. Such an implementation allows for a rapid response that mitigates or avoids latency due to limitations of the speed of a camera's zoom motor when altering the level of zoom.

In yet another alternate embodiment, multiple cameras with different fixed zoom levels are provided, however, rather than pointing outward toward the space around the aircraft 10, the cameras point inward (in the direction of the interior of the aircraft) toward an outward-facing mirror. That is, the cameras are arranged to capture the image reflected in a mirror, which image is of an area of space exterior to the aircraft 10. For instance, three cameras at different fixed zoom levels may be directed to the same mirror, so as to capture the same area of space (or the same approximate areas of space, as the boundaries of the image capture may vary based on zoom level). In response to a particular likelihood of detection, the scheduler 350 (or a dedicated compute at the instruction of the scheduler) may select a camera that is already set at an appropriate zoom level. If necessary, the mirror may be panned or titled to allow the fixed-zoom camera to capture a different area of space. Such an implementation allows for a rapid response that mitigates or avoids latency due to limitations of the speed of a camera's zoom motor when altering the level of zoom, as well as latency due to inertia in moving one or more cameras to an appropriate position.

Through the systems and methods described above with reference to FIGS. 3-6, intelligent computation may be done by the scheduler, and the dedicated computes may focus on (or otherwise prioritize) the processing of data from image sensors that are most likely to depict object of interest to the aircraft. By these means, the processing capabilities of the sensing system can be optimized.

Mixer Architecture

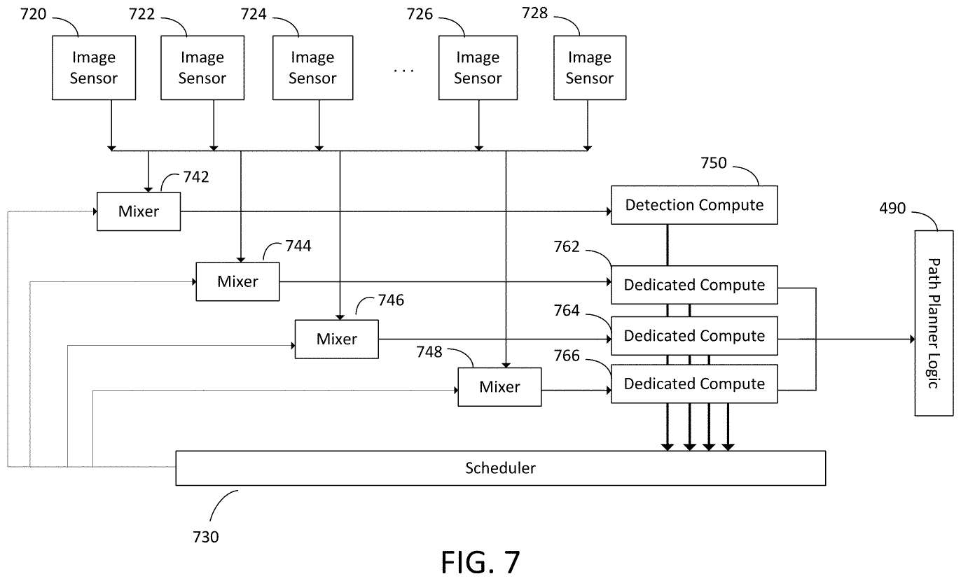

FIG. 7 illustrates an embodiment with a plurality of image sensors 720, 722, 724, 726, and 728. These image sensors and path planner logic 490 can be understood to be generally similar to analogous components illustrated in FIGS. 3, 4, and/or 6 described above. In the illustrated embodiment of FIG. 7, rather than a multiplexer module into which all image sensor feeds flow, the sensing system 5 instead uses a plurality of mixers 742, 744, 746, and 748. In this embodiment, each mixer has access to each of the image sensor feeds such that mixer 742 (or any other mixer) can receive image sensor feeds from any, all, or any subset of image sensors 720-728.

In a preferred embodiment, each mixer is implemented on a respective single chip (e.g., a FPGA or ASIC). Because of the large number of image sensors often needed provide full sensor coverage around an aircraft (although only 5 image sensors are depicted in FIG. 7), each of the mixers 742-748 has access to a large amount of data, and must perform computationally heavy processing thereon. Accordingly, it will be generally understood that, where the functionality of a mixer is implemented through circuitry, such an implementation will generally result in faster processing. However, in other embodiments, where processing demands require a more robust, or otherwise different, performance permitted by a CPU, a mixer may be implemented by any of hardware, software, or any combination thereof.

The illustrated embodiment of FIG. 7 depicts a cycle of information between the mixers 742-748, the detection compute 750 and/or dedicated computes 762, 764, and 766, and the scheduler 730. To begin, the mixers 742-748 provide image streams from the image sensors to the detection compute 750, which processes such data in a robin round manner with respect to the different image sensors. In a first embodiment, the result of detection compute 750's processing is a “heat map” that lays out the particular parts of the field of view of an image sensor that are more or less likely to contain an object of interest. The heat map of the FOV of an image sensor may be generated from one or more percentages representing a likelihood of detection of an object of interest at a particular position in the image (similar to the likelihood of detection discussed above with respect to FIGS. 4-6). The detection compute 750 may generate this heat map and transmit it to the scheduler 730. In some embodiments, the heat map may comprise a set of percentage values and/or associated location information (such as, e.g., coordinates, a pixel number, etc.) representing different likelihoods of detection within an image. That is, rather than assigning a percentage value of likelihood of detection to an image sensor feed, the percentage value is assigned to a particular point (and, in fact, every point) of the field of view captured by the image sensor. Put another way, for purposes of the heat map, the likelihood of detection is stored in association with a portion of real space rather than in association with an image sensor stream. In other embodiments, the heat map may take the form of a graphical representation developed from such percentage and location information. In yet another embodiment, rather than percentage value, the heat map data may instead associate particular locations in the FOV with a categorical value representing one of several different ranges of likelihood of detection (e.g., “high”, “medium”, and “low” or a range of colors, red-blue, among other appropriate categorizations). If collision is imminent, the detection compute 750 may assign a high percentage (e.g., 100% or 107%), a representative characterization higher than “high” or red, or another such abnormally high or outlier value, to ensure that priority is given to that area of space.

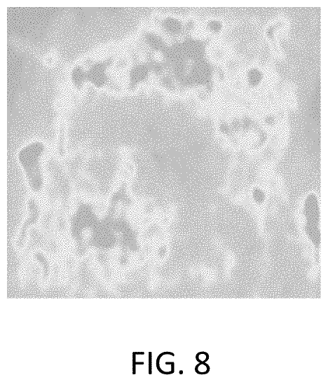

In a preferred embodiment, the detection compute 750 sends the generated heat map (e.g., percentage and location information) to the scheduler 730, and the scheduler 730 stores the heat map (or information therefrom) in a table or other appropriate data structure. The scheduler 730 may use heat map data from all of a subset of image sensors to generate a global heat map. This global heat map may contain data sufficient to correspond to the entire observable spherical area 200 around the aircraft 10 (FIG. 2), or in some embodiments a subset thereof. In some embodiments, the global heat map may be a table with comprehensive information from image sensors 720-728, however, in other embodiments, the global heat map may be (or may correspond to) a graphical representation. One example of a graphical global heat map is shown in FIG. 8, although different types of representations may be used in different embodiments. The heat map of FIG. 8 is a graphical representation in grayscale or black and white, with areas of a higher likelihood of detection shown in a darker color, while areas of a lower likelihood of detection are shown in a lighter color. In other embodiments, a global heat map may be graphical representation in color, with areas of a high likelihood of detection shown in, e.g., red and areas of low likelihood of detection shown in, e.g., blue. Other embodiments may use other graphical or non-graphical methods of delineation between different areas, so long as “hot spots” with high likelihood of detection may be determined and differentiated from other areas.

Scheduler 730 uses the global heat map to determine which portions of the spherical field of view (FOV) around the aircraft make up areas of interest (AOI) to the scheduler. Put another way, the areas of interest may be geospatial areas within the spherical region 200 that is observable by the sensors 20 of the aircraft 10. In a preferred embodiment, an AOI may represent all or part of a global heat map with a relatively high likelihood of detection. Where no portion of the heat map has a high area of detection, the AOI may be, for instance, the area with the highest likelihood of detection, an area in which objects are historically more commonly detected, a “blind spot” of a human operator or pilot, or a randomly selected area from the available field of view of the sensors.

Once the AOIs have been determined, scheduler 730 may instruct one or more mixers (which respectively correspond to dedicated computes 762, 764, 766) to capture an image of a particular AOI. This is done by sending a selected mixer a set of information including at least: a center point of the AOI, one or more values from which the size of the AOI can be determined, and a resolution at which to capture images of the AOI. This information may be understood to define a particular portion of the FOV around the aircraft (e.g., in the case of a spherical FOV, a curved plane of observable space) without regard to the boundaries of observation of any image sensor 720-728. That is, the AOI defined by the scheduler does not correspond to the FOV of any given image sensor, though it may overlap all or part of that FOV. In addition, the scheduler 730 is not limited to defining one AOI, and a larger number of AOIs may be appropriate where multiple hot spots exist on the global heat map. With reference to the illustration of FIG. 7, the scheduler 730 may wish to take advantage of all available computing resources, and may therefore define at least three AOIs to be processed by dedicated computes 762, 764, 766, whether or not three hot spots exist on the global heat map. The scheduler 730 is also not limited to a 1:1 correspondence between areas of interest and dedicated computes, and may instead assign multiple AOIs to be processed by a single mixer and a single dedicated compute, although other assignments may be possible in different embodiments.

After selecting a center point of an AOI, the scheduler 730 calculates the size of the area of interest based on an analysis of the global heat maps. In one embodiment, scheduler 730 implements a randomized gradient walk algorithm, or any other known algorithm, to identify the boundaries of an AOI. In a preferred embodiment, the size of the area of interest is provided to the mixer as a pitch/yaw value so as to define a curved plane (that is, e.g., part of the spherical area 200 illustrated in FIG. 2, e.g., 210-a). In other embodiments, the size of the area to be observed can be expressed to the mixers by different values, such as, e.g., a height/width value of a distance, a number of pixels, or a number of degrees.

In addition to the center point and the size of the AOI, scheduler 730 may also instruct the mixers 742, 744, 746, 748 to process image data at a particular resolution. The resolution is determined by the scheduler based on the likelihood that something may be detected within that AOI. For example, where the scheduler has instructed mixer 744 to process an AOI with a high likelihood of detection, and has instructed mixer 746 to process a second AOI with a mid-range or low likelihood of detection, mixer 744 may be instructed to use a higher resolution (and therefore, more processing resources) than mixer 746, and thereby put more attention on the AOI with the highest area of interest. In general, it can be understood that scheduler 730 may preferable use algorithms that result in areas of lesser interest being assigned lower resolution and larger image sizes (that is, less fine detail is required in an image with a lower likelihood of detection).

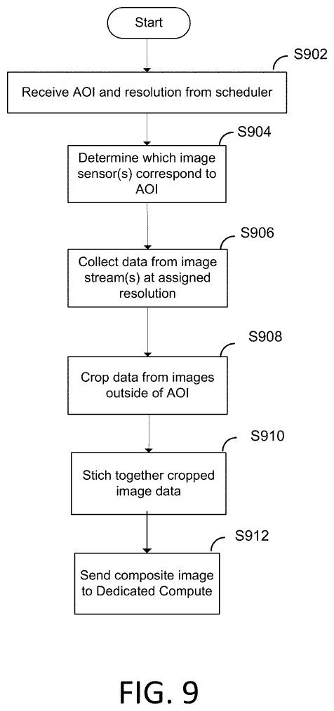

In the case of mixer 742 in FIG. 7, which outputs to the detection compute 750, the mixer continues to provide, in a round robin manner, data from each of the image sensors, at a high resolution. Mixer 742, which sends data to the detection compute 750, may in some instances perform filtering or image processing (e.g., for brightness correction, or to filter known innocuous obstacles), but does not perform any extensive image manipulation or processing. Mixer 742 therefore sends entire image data in high resolution to the detection compute 750. By these means, at least one of the compute elements continues to look at the entirety of the space around the aircraft 10. In the case of mixers 744, 746, and 748, however, each respective mixer produces a customized image frame corresponding to their assigned area and resolution of their AOI, through image filtering, cropping, and or stitching. One example of such processing is set out in FIG. 9.

FIG. 9 depicts a flow chart of steps taken by a mixer 744 in response to receiving an AOI from scheduler 730, in accordance with an embodiment of the disclosure. It will be understood that any of the mixers 744-748 may function similarly in accordance to instructions received from the scheduler 730. In Step S902, mixer 744 receives an AOI and resolution setting from scheduler 730. The AOI information includes both a center point of the AOI and a size value (e.g., a pitch and yaw), from which data the mixer 744 may determine one or more sensors with a FOV covering the intended AOI (step S904). Typically, the FOV of an image sensor will not align exactly with an AOI, and therefore, image data from multiple image sensors may be necessary to cover the entirety of the AOI. Because mixer 744 has access to data from all of the image sensors, the mixer, being aware of the particular space imaged by each image sensor, can access relevant image data without cycling through data from all of the image sensors 720-728. In the embodiment of FIG. 9, when collecting the images from the image sensors (Step S906), the mixer 744 may specify that data should be sent at a certain resolution, however, in other embodiments, the mixer 744 may later manipulate the received image data.

In most circumstances, the collection of data from the multiple image sensors may contain a subset of image data relating to space outside of the intended AOI. In order to minimize the amount of data that it needs to process, mixer 744 may crop from the collected images all image data that does not fall within the boundaries of the AOI (step S908). The mixer may then be left with one or more cropped images (or a combination of cropped and uncropped images), all of which contain only images of space within the AOI. Mixer 744 may then create a single composite image of the AOI by stitching together the cropped images (step S910). The stitching process may be, in some embodiments, a computationally intensive process. Further, in cases where there is some overlap between the field of view of two or more image sensors, the mixer 744 may need to detect and remove duplicative or redundant information during stitching. In some embodiments, mixer 744 may compare images from different sensors and may select an image (or a portion of an image) with a best quality. Once a composite image has been generated, mixer 744 may also process such composite image, if necessary, for color and brightness correction and consistency, or for other relevant image manipulation. The processed composite image may then be sent, in step S912, to the dedicated compute associated with the mixer, here dedicated compute 762, for analysis. In a case where multiple AOIs are assigned to mixer 744, this process is repeated for each of the AOIs.

Because AOIs are assigned by the scheduler even if the likelihood of detection is low, each of dedicated computes 762, 764, and 766 will consistently be assigned to at least one area of interest. By these means, the robust processing capabilities of the dedicated computes are regularly utilized and are not wasted.

Dedicated computes 762, 764, and 766, upon processing the image data received from their respective mixers 744, 746, and 748, provide heat map data to the scheduler 730 in a manner similar to that of the detection compute 750 described above. However, unlike the detection compute 750, before the dedicated computes generate a heat map, they first characterize, localize, and/or determine attributes of the detected object in a manner similar to that described above with respect to dedicated computes 460-464 in FIGS. 4-6. The dedicated computes may then take that additional information into consideration during their generation of a heat map. The dedicated computes 762-766 also provide information about the attributes of the dedicated objects to path planner logic 490, which may recommend a path to avoid collision with the object.

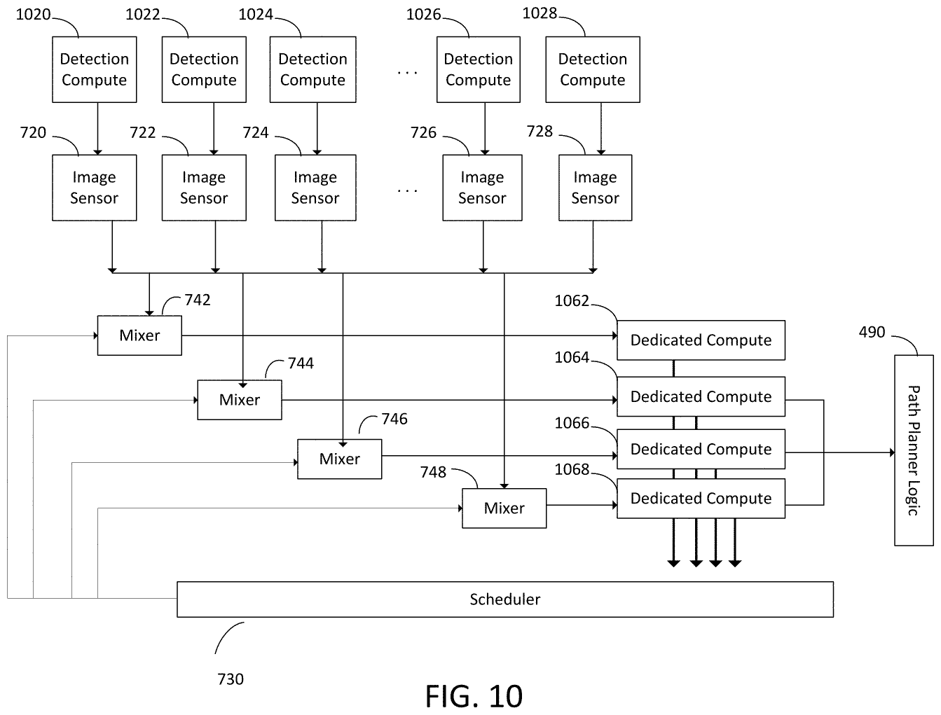

In an alternate embodiment, rather than a single detection compute 750, discrete circuitry effecting the functions of the detection compute can be attached to each of the respective image sensors, as illustrated in FIG. 10. As shown, detection computes 1020-1028 may be implemented by hardware (e.g., a FGPA or ASIC, or other appropriate type of chip), but may otherwise function in a manner similar to that of detection compute 750. The implementation of the functions of the detection computes through circuitry may aid in the faster processing of the large amounts of data handled by the detection computes, by limiting a particular detection compute (e.g., 1020) to only image data from a particular image sensor (e.g., 720). In the embodiment of FIG. 10, mixers 742-748 are each associated with a respective dedicated compute 1062-1068.

By these means, the dedicated compute modules are provided with intelligently selected areas of interest, without receiving extraneous image data. The areas of interest are not limited to the field of view of any single image sensor, but instead, are selected from a global view of the space around the aircraft. By these means, the most critical areas of detection are prioritized in a dynamic selection by the scheduler. In addition, detection of objects that may be located in the border between two or more image feeds can be more easily performed, without excessive redundancy of image processing. Further, because the mixers are configured to crop and filter image data, the dedicated computes can process a minimal amount of data, thus saving bandwidth and processing resources, particularly where the AOI spans only a very narrow area.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A monitoring system for an aircraft, the monitoring system comprising:
a plurality of sensors configured to sense an area external to the aircraft;
a multiplexer configured to obtain image information from the plurality of sensors, the image information including first image information corresponding to a first sensor of the plurality of sensors and second image information corresponding to a second sensor of the plurality of sensors;
a first module configured to process image information received from the multiplexer comprises the first image information and the second image information, and to generate a first likelihood of detection value based on the first image information and a second likelihood of detection value based on the second image information;
a second module configured to process image information received from the multiplexer; and
a scheduler module;
wherein the scheduler module is configured to, based on the first likelihood of detection value and the second likelihood of detection value, instruct the multiplexer to transmit to the second module the first image information, and
wherein the second module is further configured to process the first image information and, based on the processed first image information, (a) detect an attribute of an object in the field of view of the first sensor, and (b) transmit to the scheduler module a third likelihood of detection value based on the detected attribute.

2. The monitoring system of claim 1, wherein the first module processes the first image information and the second image information in a round robin manner.

3. The monitoring system of claim 1, wherein the second module processes the first image information without processing the second image information.

4. The monitoring system of claim 1, wherein the second module is further configured to send, to a path planning module of the aircraft, information regarding the detected attribute of the object.

5. The monitoring system of claim 1, wherein the first module is implemented by a field-programmable gate array.

6. A monitoring system for an aircraft, the monitoring system comprising:
a plurality of sensors positioned on the exterior of the aircraft, each of the plurality of sensors being configured to sense objects within a respective field of view external to the aircraft;
a scheduler module configured to generate information sufficient to identify an area of interest external to the aircraft; and
a mixer module configured to, based on the information sufficient to identify the area of interest:
(i) obtain image data from the plurality of sensors, the image data including first image information corresponding to a first sensor of the plurality of sensors and second image information corresponding to a second sensor of the plurality of sensors,
(ii) remove, from one or more of the first image information and the second image information, information that is unrelated to the area of interest so as to obtain first revised image information and second revised image information, and
(iii) generate composite image data by combining the first revised image information and the second revised image information.

7. The monitoring system of claim 6, wherein no information is removed from the second image information, such that the second revised image information is identical to the second image information.

8. The monitoring system of claim 6, wherein each of the plurality of sensors is an optical camera.

9. The monitoring system of claim 6, wherein the plurality of sensors are capable of sensing data of a spherical area surrounding the exterior of the aircraft.

10. The monitoring system of claim 6, wherein the information sufficient to identify an area of interest external to the aircraft includes (a) a center point of the area of interest, (b) a pitch value of the area of interest, (c) a yaw value of the area of interest, and (d) a resolution value for an image of the area of interest.

11. The monitoring system of claim 6, further comprising:
a compute module configured to process the generated composite image data, to detect an object within the generated composite image data, and to determine at least one attribute of the detected object.

12. The monitoring system of claim 6, further comprising:
a compute module configured to (a) process the generated composite image data, (b) determine, based on the generated composite image data, a likelihood of that an object may be detected in the generated composite image data, and (c) transmit the determined likelihood of detection to the scheduler module.

13. The monitoring system of claim 12, wherein the compute module transmits the determined likelihood of detection to the scheduler module in the form of a heat map that includes information indicating a likelihood of detection at a plurality of points in the generated composite image data.

14. The monitoring system of claim 13, wherein the scheduler module receives the transmitted heat map, and generates a global heat map that includes information indicating a likelihood of detection at a plurality of points within a spherical area surrounding the exterior of the aircraft.

15. A method performed by an image processing module of an aircraft monitoring system, the method comprising:
obtaining information sufficient to identify a geospatial area of interest external to the aircraft;
collecting image data from one or more sensors capable of sensing data of an area external to the aircraft, the collected image data including first image data from a first sensor and second image data from a second sensor;
determining that the first image data contains information regarding a geospatial area other than the geospatial area of interest;
modifying the first image data to remove image data regarding a geospatial area other than the geospatial area of interest;
generating composite image data from the first image data and the second image data; and
determining, based on the composite image data, a value associated with a likelihood that an object may be detected in the composite image data.

16. The method of claim 15, wherein the information sufficient to identify a geospatial area of interest external to the aircraft includes (a) a center point of the geospatial area of interest, (b) a pitch value of the geospatial area of interest, and (c) a yaw value of the geospatial area of interest.

17. The method of claim 15, wherein the information sufficient to identify a geospatial area of interest external to the aircraft further includes a resolution value for an image of the geospatial area of interest.
